(19) United States
(12) Patent Application Publication
(10) Pub. No.: US 2014/0054976 A1
(43) Pub. Date: Feb. 27, 2014

(54) SYSTEM AND METHOD FOR CONTROLLING ENVIRONMENTAL CONDITIONS WITHIN AN ENCLOSED SPACE

(71) Applicants: Lidong Ni, Yueqing (CN); Wei Gao, Yueqing (CN)

(72) Inventors: Lidong Ni, Yueqing (CN); Wei Gao, Yueqing (CN)

(73) Assignee: WENZHOU MTLC ELECTRIC APPLIANCES CO., LTD., Yueqing (CN)

(21) Appl. No.: 13/595,951

(22) Filed: Aug. 27, 2012

(51) Int. Cl. H01H 37/00; H01H 35/00

(52) U.S. Cl. 307/117; 307/116

(57) ABSTRACT

A system for controlling a power input to a load includes a gate action monitor configured to transmit a door activation signal corresponding to an opening or closing of an access way to an enclosed space, a double signal sensor configured to transmit an occupancy signal corresponding to a detected occupancy of the enclosed space and a temperature signal corresponding to a detected temperature of the enclosed space, and a controlled load switch configured to detect one or more of the door activation signal, occupancy signal and temperature signal, and enable or disable the power input to the load.

### BACKGROUND

The aspects of the disclosed embodiments generally relate to controlling power to an electrically powered apparatus, and in particular to controlling power to a climate control system.

Energy is the basic power requirement for all electrically operated machines. Saving energy and decreasing the daily consumption of energy are important factors in reducing operational costs. The energy requirements of climate control systems, such as air conditioning systems, are quite high. It would be advantageous to automatically control the power used by air conditioning systems to reduce energy consumption.

Conventional power supply systems for rooms are mainly designed for manual control systems. For example, the ON and OFF switching of lighting and air-conditioning systems conventionally requires users to manually operate the room controls. When no one is in a room, the unneeded operation of lighting and air-conditioning is a costly waste of electricity.

A conventional Passive Infrared (PIR) device or switch is generally configured to detect human body motion in a room. Such PIR devices are typically used to automatically control the ON/OFF state of electrical power that is supplied to a device, such as lighting or air conditioning. However, when no motion is detected within a predetermined period of time, the PIR switch will undesirably cause the electrical power to turn off, even if a person is in the room. Examples of undesired results of power termination because of a lack of motion detection can include turning OFF a computer suddenly with a resulting loss of open computer files, or turning OFF the air conditioning when people are still in the room, such as when they are motionless in the room during sleep. It would be advantageous to be able to utilize a PIR device to control electrical power to an electrically powered device such as a light or air conditioner, in a smart and efficient manner, based not only on motion, but also on the presence of a person in a room.

Accordingly, it would be desirable to provide a system that addresses at least some of the problems identified above.

### BRIEF DESCRIPTION OF THE INVENTION

As described herein, the exemplary embodiments overcome one or more of the above or other disadvantages known in the art.

In one aspect, the disclosed embodiments are directed to a system for controlling a power input to a load. In one embodiment, the system includes a gate action monitor configured to transmit a door activation signal corresponding to an opening or closing of an access way to an enclosed space, a double signal sensor configured to transmit an occupancy signal corresponding to a detected occupancy of the enclosed space and a temperature signal corresponding to a detected temperature of the enclosed space, and a controlled load switch configured to detect one or more of the door activation signal, occupancy signal and temperature signal, and enable or disable the power input to the load.

In another aspect, the disclosed embodiments are directed to a method for controlling a switch to power a load in a monitored enclosed space. In one embodiment, the method includes detecting a door action associated with an entranceway to the enclosed space, determining an occupancy of the enclosed space, and activating the switch to power the load when the door action is associated with the detected occupancy of the enclosed space.

In a further aspect, the disclosed embodiments are directed to a system for controlling power to a climate control apparatus of an enclosed space having an access door. In one embodiment, the system includes a gate-action monitor configured to monitor an opening or closing of the access door; a double signal sensor configured to detect movement within the enclosed space and a temperature within the enclosed space; a controlled load switch coupled to a supply of electrical power and the climate control apparatus, and configured to enable or disable electrical power to the climate control system based on the door activation and one of the detected movement and the temperature within the enclosed space; and a communication interface communicatively coupled to and between the gate action monitor, double signal sensor and controlled load switch to enable communication of data and commands.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is a block diagram of one embodiment of a power control system incorporating aspects of the present disclosure.

FIG. 2 is a block diagram of one embodiment of a power control system incorporating aspects of the present disclosure.

FIG. 3 is a schematic diagram of one embodiment of a circuit for a gate action monitor incorporating aspects of the present disclosure.

FIG. 4 is a schematic diagram of one embodiment of a circuit for a double signal sensor incorporating aspects of the present disclosure.

FIG. 5 is a schematic diagram of one embodiment of a circuit for a controlled load switch incorporating aspects of the present disclosure.

FIG. 6 is a block diagram of an embodiment of a power control system incorporating aspects of the present disclosure that includes a remote host.

FIG. 7 is a flowchart illustrating one embodiment of an exemplary process flow for a power control system incorporating aspects of the present disclosure.

FIG. 8 is a flowchart illustrating one embodiment of an exemplary process flow for a power control system incorporating aspects of the present disclosure.

### DETAILED DESCRIPTION OF THE EXEMPLARY EMBODIMENTS OF THE DISCLOSURE

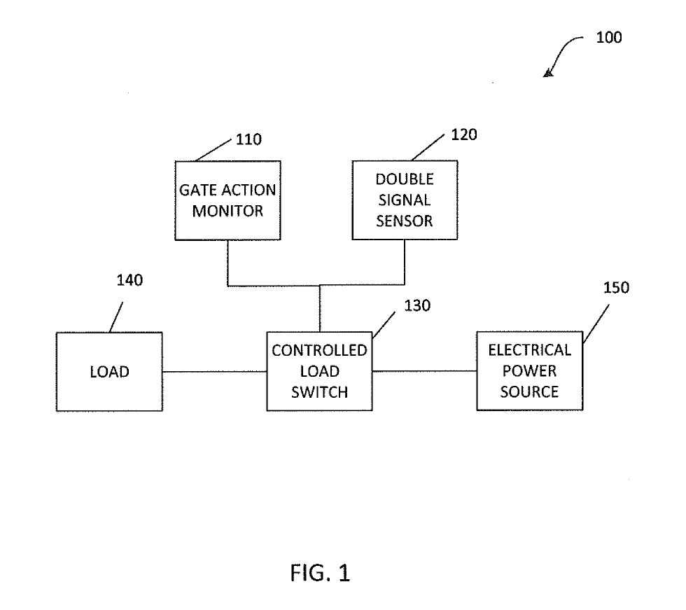

Referring to FIG. 1, an exemplary power control system for an electrically powered machine incorporating aspects of the disclosed embodiments is generally designated by reference numeral 100. The aspects of the disclosed embodiments are generally directed to automatically controlling the power to an electrically powered load or device 140, such as a climate control system, based on a detected presence or occupancy of the room. While the aspects of the disclosed embodiments will generally be described herein with respect to load 140 comprising a climate control system or heating and air conditioning (HVAC) system, it will be understood that the scope of the disclosed embodiments is not so limited, and the load 140 can included any electrically powered device that can be switched or turned ON and OFF.

In the embodiment shown in FIG. 1, the power control system 100 of the disclosed embodiments, also referred to as a smart power supply system, generally includes a gate action monitor 110, a double signal sensor 120, and a controlled load switch 130.

In one embodiment, the gate action monitor 110 includes a gate switch detect circuit which is used to detect gate action, such an entrance door opening and closing access to a room or enclosed space. The gate action monitor unit 110 may also include micro switch detect circuits such as a passive infrared monitor circuit and/or a reed type displacement sensor circuit. In one embodiment, the gate action monitor 110 is configured to be placed at an entranceway to an enclosed space or area, such as a door to room, that is monitored as is generally described herein. Although the aspects of the disclosed embodiments will generally be described with reference to a room, in alternate embodiments, any suitable space or area is contemplated, including for example, but not limited to, halls, garages, offices, cubicles, foyers, bathrooms, garages, auditoriums or large enclosed spaces or other areas where control of devices using electrical power is contemplated.

In one embodiment, the double signal sensor 120 is configured to detect occupancy of an area based on detected movement within the space, as well as a temperature or temperature differential within the space. The double signal sensor 120 is configured to be placed in a high area of the space that allows for maximal sensing of movement and occupancy, such as for example the ceiling, and preferably in a corner. The double signal sensor 120 is configured to communicate with the controlled load switch 130 over a wired or wireless network, such as those generally described herein. The ceiling double signal sensor may include a power plug or may, for battery powered operation, include batteries. The double signal sensor 120 can also include a central processing unit CPU circuit, an infrared signal sensor circuit, temperature signal sensor circuit, wireless transceiving circuit and a switch circuit.

The controlled load switch 130 is configured to communicatively interface with the double signal sensor 120 and the gate action monitor 110 and control the switching of the power to the load 140 ON and OFF. One aspect of the present disclosure relates to an automatic ON/OFF load power smart power supply control system for an environmentally controlled enclosed space. In one embodiment, the controlled load switch 130 may include a relay driving circuit and a relay connected to the output of the relay driving circuit and a controlled load circuit. The relay driving circuit is controlled ON/OFF by the central processing unit that drives the control input of relay driving circuit. A central processing unit determines the setting of the relay through inputs such as infrared sensor transfer information and temperature sensor transfer information from the double sensor unit 120 and door closure information from the gate action monitor 110.

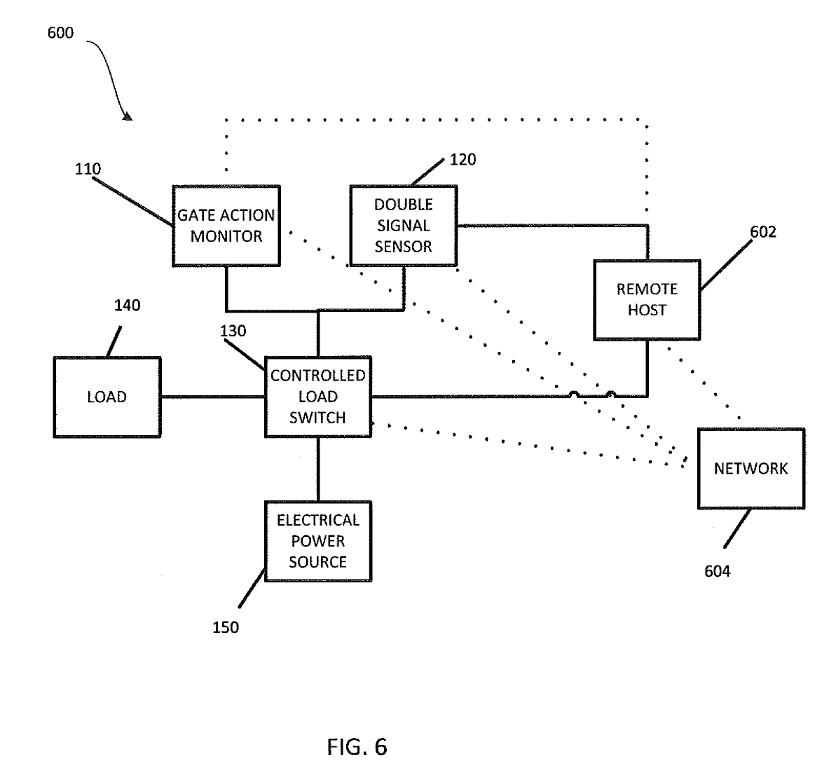

The controlled load switch 130 can also include a central processing unit CPU circuit, a DC power circuit and a wireless transceiving circuit. In one embodiment, the power control system 100 may be configured or configurable to communicate with a remote host 602, shown in FIG. 6, through a wireless connection using a suitable wireless communication protocol such as WiFi or Z-Wave, Zigbee, or via a wired connection as by cable. Each of the gate action monitor 110, the double signal sensor 120 and the controlled load switch 130 can include one or more of a central processor unit and wired or wireless communication capability to transmit and exchange information and data to and between each other, as well as with the remote host 602 or other communication devices and systems.

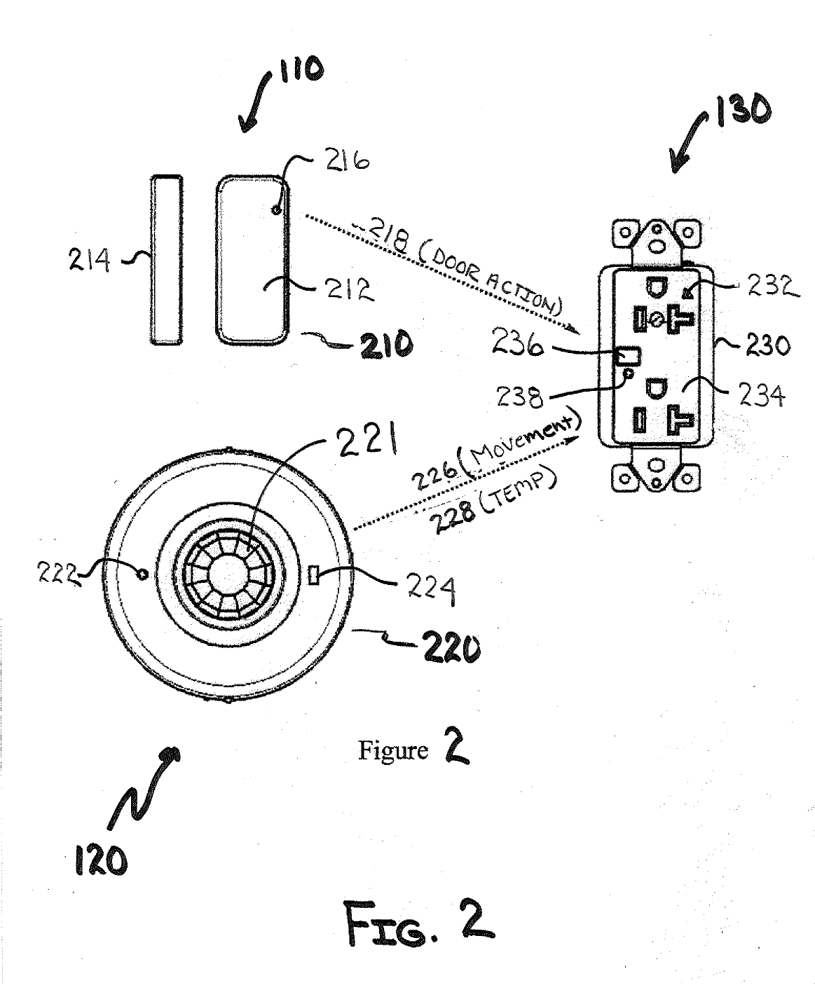

FIG. 2 illustrates one embodiment of the system 100. As is illustrated in FIG. 2, the system 100 generally includes a gate-action monitor 110, a double signal sensor 120 and a controlled load switch 130. In this embodiment, the gate-action monitor 110 generally comprises a door sensor 210. The double signal sensor 120 comprises a PIR sensor 220 and the controlled load switch 130 comprises a controlled power outlet 230. Although the controlled load switch 130 will be generally referred to as a controlled power outlet, in alternate embodiments, the controlled load switch 130 comprises any electrical switching source that can be activated or enabled to provide a source of electrical power, and de-activated or disabled to provide no power. In one embodiment, the controlled load switch 130 includes suitable relays or switching devices that are configured to connect and disconnect a source of electrical power to the control load switch 130, as will be generally described herein.

The door sensor 210 and PIR sensor 220 are generally configured to communicate with the controlled power outlet 230 to control power to an electrically powered load 140 that is electrically connected to the controlled power outlet 230 in a suitable manner. For example, in one embodiment, the load 140 could be plugged into the controlled power outlet 230 or hard-wired to the controlled power outlet 230.

In one embodiment, the door sensor 210 is a magnetic type door sensor that includes a magnetic sensor portion 212 and a magnet fixed box portion 214. One of the magnet sensor portion 212 and the magnet fixed box 214 is affixed to a door to a room, while the other is affixed to the frame portion of the door. The sensor 212 and box 214 can be affixed in any suitable manner, including bonding, glue, tape or screws, for example. In one embodiment, the sensor 210 could be mounted to a window or other suitable opening or entrance to room or space. As will generally be understood, the two parts 212, 214 need to be spaced apart in a suitable manner to ensure a magnetic coupling or connection.

In one embodiment, the magnetic sensor 210 is suitably powered with electric energy using for example batteries or a hard-wire connection to a power source. The magnetic sensor 210 is generally configured to detect relative movement between the sensor portion 212 and the magnet fixed box 214. In the embodiment shown in FIG. 2, the sensor 210 includes an indicator 216, such as a light emitting diode (LED) that provides a visual door open/close signal 218. In one embodiment, the signal 218 comprises a flashing of the LED 216. Although a visual signal is generally described herein, in one embodiment, the sensor 210 can also be configured to generate an audible open/close signal. The magnetic sensor 210 is generally configured to transmit the open/close signal 218 to the controlled power outlet 230.

In one embodiment, the PIR sensor 220 comprises a passive infrared occupancy sensor 221 that includes a temperature sensor 222 and an indicator 224. The PIR sensor 220 can be used in conjunction with the controlled power outlet 230 to control the load 140 that is electrically connected to the controlled power outlet 230. For example, in one embodiment, the PIR sensor 220 can cause the controlled power outlet 230 to provide electrical power to the load 140. The term “electrical power” is generally intended to include any supply of electrical power suitable for the particular application and geographical location and can include for example any one or more of 120/240/480 VAC, as well as 50/60 Hz. While not common, direct current (DC voltage) applications are within the contemplated scope of the disclosed embodiments.

The controlled power outlet 230 is generally configured to provide electrical power to a load 140 that is connected thereto. As is shown in FIG. 2, in this embodiment, the controlled power outlet 230 generally comprises an electrical receptacle configured to receive a plug of an AC cord 242 of the load 140. The exemplary blade configuration of the controlled power outlet 230 is merely representative of a particular application, such as in the United States, and in alternate embodiments, any suitable electrical blade configuration can be utilized, generally depending on the type of electrical power system the controlled power outlet 230 is connected to or receiving power from, and the country in which the system 100 is being used. For example, the electrical power outlet and receptacle blade configuration in the United States is different that the blade configuration(s) used in Europe. The aspects of the disclosed embodiments are intended to encompass all suitable blade configurations and electrical power outlet configurations for electrical power outlets and receptacles.

The exemplary controlled power outlet 230 shown in FIG. 2 is illustrated as a duplex electrical receptacle and includes a controlled receptacle 232 and a regular, or non-controlled receptacle 234. In alternate embodiments, the controlled power outlet 230 can include any number of receptacles, such as one or four, and any number of combinations of control 232 and regular 234 receptacles, such as 1:1; 2:1, 3:1, 1:2 or 1:3.

In the embodiment shown in FIG. 2, the controlled power outlet 230 includes a function button 236 and an indicator 238. In the embodiment shown herein, the indicators 216, 224and 238 are generally shown as LEDs. In alternate embodiments, the indicators 216, 224 and 238 can comprise any suitable indicators, such as infra-red or audible indicators.

When a load 140 is connected to or plugged into the controlled receptacle 232, in one embodiment, an auto power control mode of the system 100 is activated. In this auto power control mode, the controlled power outlet 230 is activated by a signal from one or more of the door sensor 210 or PIR sensor 220 to turn power ON or OFF. The door sensor 210 provides a door open/close signal 218. The PIR sensor 220 is configured to provide one or both of an occupancy signal 226 and temperature signal 228. If the load 140 is connected to or plugged into the non-controlled or regular receptacle 234, the load 140 will not be controlled by the system 100 as is described herein, and will operate in a normal fashion.

The PIR sensor 220 is configured to be used with the controlled power outlet 230 to control the load 140 connected to the controlled receptacle 232. In one embodiment, the load 140 is activated or kept ON when the PIR sensor 220 detects that the room is occupied, referred to herein as “occupancy”. If the door sensor 210 provides an indication of a subsequent door opening or closing and no further movement is detected, the controlled power outlet 230 can deactivate the load 140, in a manner as generally described herein.

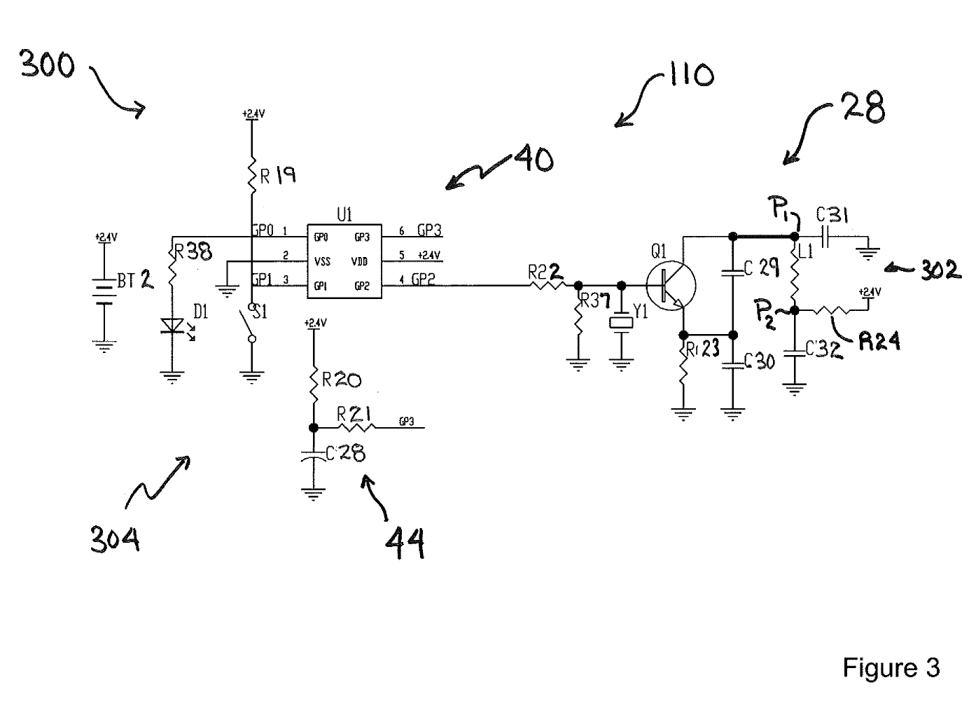

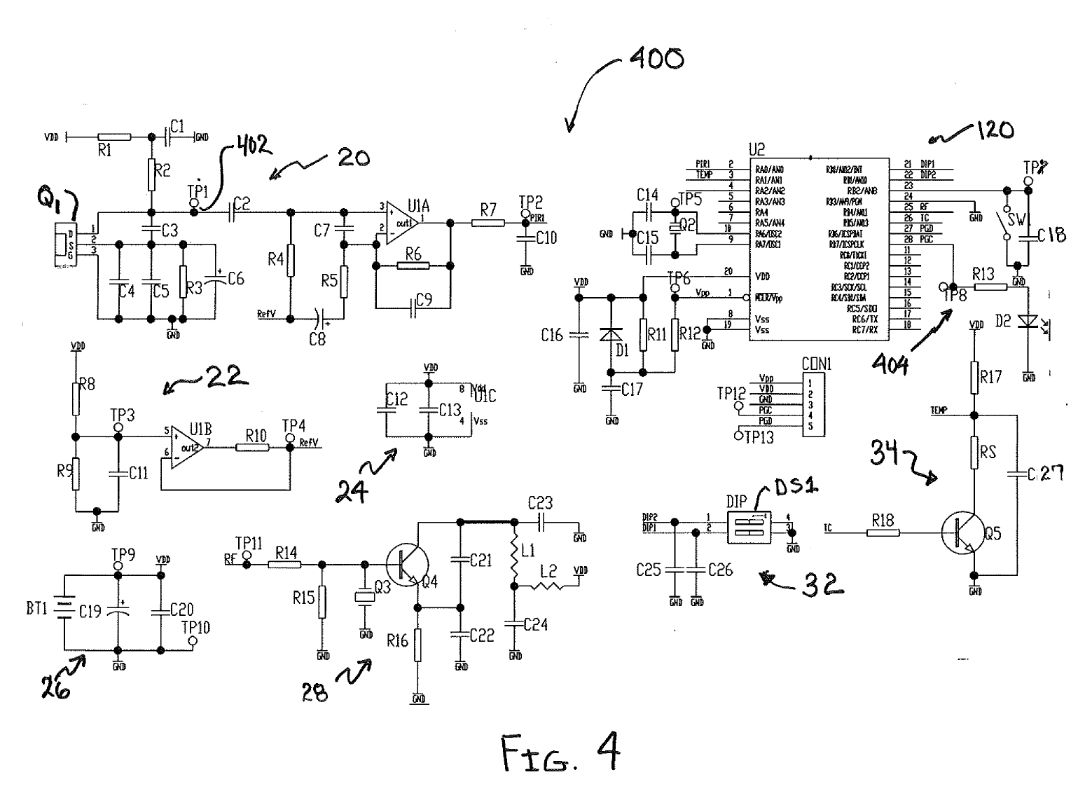

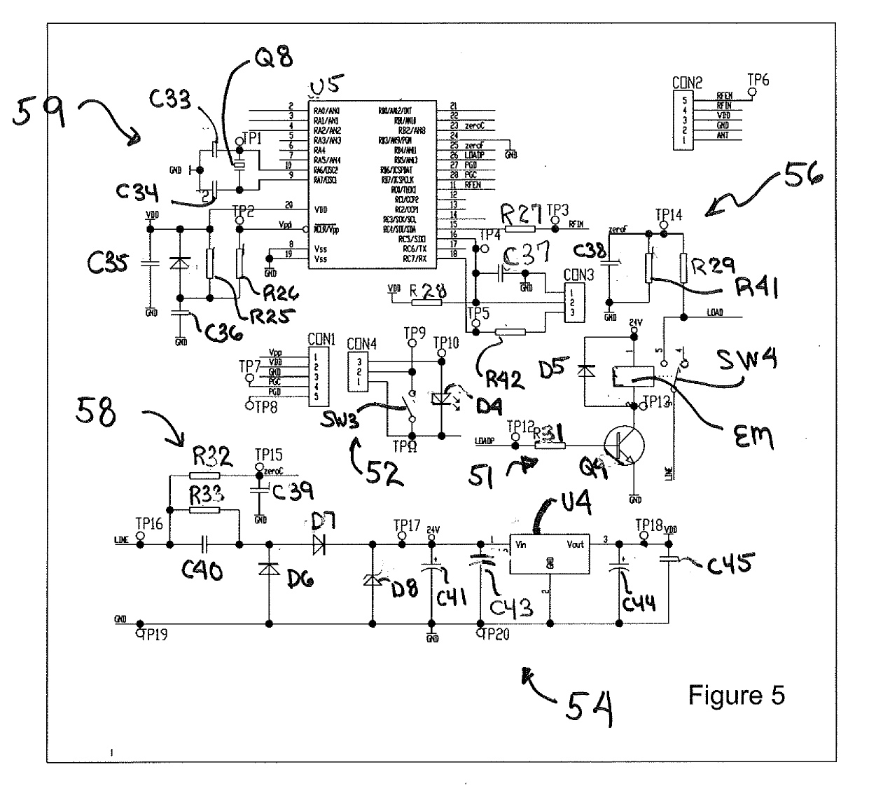

FIG. 3 illustrates one embodiment of a schematic diagram of a circuit 300 for the gate action monitor 110 of FIG. 1. FIG. 4 illustrates one embodiment of a schematic diagram of a circuit 400 for the double signal sensor 120 of FIG. 1 and FIG. 5 illustrates one embodiment of a schematic diagram for a circuit 500 of the controlled load switch 130 of FIG. 1.

As shown in FIG. 3, in this embodiment of the gate action monitor 110 includes a gate action detection circuit 40 used to detect gate action, or the opening and closing of a door. In one embodiment, the gate action detection circuit 40 includes a pullup resistor R19 connected to a switch S1. This switch S1 may be implemented, for example, at the site of a door lock of an entrance door to a room being monitored. The central processing unit (CPU) U1 circuit reads the state of the switch S1 as either open or closed, meaning that the entrance door is opened or closed. The CPU U1 transmits the state of the switch S1 through a transmission circuit (e.g., wireless transceiving circuit) comprising voltage dividing resistor pair R37 and R22, oscillator Y1, driving transistor Q1, current limiting transistor R23, and output smoothing transistors C29 and C30. The output 302 of the transmission circuit is defined by terminal points P1 and P2. The terminal points P1, P2 may connect to a component to provide a transmission path to the controlled load switch 130 and/or to the ceiling double signal sensor 120 or terminal point P1 may connect to an otherwise unconnected conductive path to serve as an antenna. In one embodiment, if terminal points P1 and P2 shown in FIG. 3 are directly, electrically connected, resistor R24 could serve as an antenna if open ended or unconnected on one end. The terminal points P1 and P2 are each connected to ground via capacitor C31 or C32 to ensure glitch free operation.

The LED indicator circuit 304 includes LED D1 and currently limiting resistor R38 and connects to the CPU central unit circuit U1 and may be illuminated to provide a person with an indication as to whether a door is open or closed. In one embodiment, switch S1 may be a reed type switch. In alternative embodiments, switch S1 may be a mini-switch or infrared sensor. Although FIG. 3 shows that the CPU U1 consists of a single chip, the CPU U1 may be implemented in other ways, such as by distributing processing units not limited to a single chip. The gate action monitor 110 may be battery operated to provide power source BT2, such as in a battery compartment with AAA or AA batteries; or, the gate action monitor 110 may have a plug for a power cord to plug into a wall socket. Circuit 44, which provides the input GP3, via the combination of resistances R20, R21 and capacitance C28, is used to detect an electrical input/output (IO) port.

Referring to FIG. 4, the processing circuit 30 processes sensor information regarding one or more conditions in an enclosed space, such as a room. (In the embodiment illustrated in FIG. 4, circuit 20 is a motion detection circuit and circuit 34 is a temperature detection circuit. Various signal state setting and voltage setting circuits 22, 24, 26, and 32 are also shown, as well as a transmission circuit 28. Power supply circuit 26 includes a battery BT1 and smoothing capacitors C19 and C20. The generated power voltage VDD may further be smoothed out by smoothing capacitor circuit 24 shown to be comprised of capacitors C12 and C13. Circuit 24 provides supply power to the amplifier in the form of VDD and VSS. Grounding circuit 32 includes a dual in line package (DIP) switch DS1 that permits input signals to be grounded where one of the DIP switches DIP1 or DIP2 may enable/disable the passive infrared occupancy sensor 221 and the other may enable/disable the temperature sensor 222 of the PIR Sensor 220 shown in FIG. 2. The grounding circuit 32 also includes two smoothing capacitors 25 and 26. Reference voltage V generation circuit 22, in the shown embodiment, shows voltage divider R8 and R9 providing a voltage input, smoothed out by capacitor C11, to the non-inverting input to operational amplifier U1B. The non-inverting input of U1B is provided with the output, RefV, that results from current limiting the output of U1B by resistor R10.

The double signal sensor 120 includes a PIR sensor circuit 20. In the illustrated embodiment of FIG. 4, the exemplary PIR sensor circuit 20 comprises infrared detecting head Q1 and its amplifying circuit. The infrared detecting head Q1 is shown with three terminals: one for grounding, one for activation by an infrared input, where this terminal is provided with a resistor R3 and capacitors C4, C5, and C6 to limit current and to removal spurious signals, and an output signal 402 that is provided to an amplifying circuit. Resistors R1 and R2 pull up the output signal 402. Capacitor C1 removes transients or glitches. Capacitor C3 also removes transients or glitches and provides that the output signal 402 is not grounded. The output signal 402 from the infrared detecting head Q1 passes through DC blocking capacitor C2. The AC signal that passes from capacitor C2 is input to the non-inverting input terminal of op amp U1A. The AC signal also passes through capacitor C7 to be input to the inverting terminal of op amp U1A. Between the non-inverting terminal and the RefV signal is an arrangement of a first line with resistor R4 and a second line formed of resistor C7, resistor R5, and electrolytic capacitor C8. Resistors R4, R5, and capacitors C7, C8 are used for the EXT circuit of the amplifier U1A. Op Amp U1A includes resistor R6 and capacitor C9 in a parallel arrangement to provide an RC time constant for the generation of an output pulse with the occurrence of a pulse corresponding to the AC signal. The generated output pulse passes through resistor R7 to become passive infrared signal PIR1 to be input to processor U2. The signal PIR1 is connected to ground through capacitor C10 so as to remove spurious signals, also referred to herein as transients or glitches.

The temperature detection circuit 34 comprises a transistor Q5 which is controlled by the input signal TC from the central processing unit U2, which may be implemented as one or more chips using, for example, ASIC or FPGA techniques. The input signal TC controls the transistor Q5 through current limiting resistor R18 at the transistor base. The emitter of transistor Q5 in this embodiment is connected to ground. A voltage divider between VDD and the collector of Q5 provides output signal TEMP at the junction of resistors R17 and RS. Resistor RS is a Thermo-Sense resistor, implemented, for example, by a thermistor. Between TEMP and ground is capacitor C27 which functions to build up charge or discharge to ground according to the bias on the base of Q5.

The processor circuit 30, including processor U2, receives a clock signal established by oscillator Q2 in which the terminals of Q2 are each connected to an input pin of U2 and, via a capacitor C4, C5, to ground. The power voltage VDD supplied to processor circuit U2 is further used to derive auxiliary power Vpp via diode D1, capacitor C17, and resistors R11 and R12. Capacitor C16 stabilizes power voltage VDD.

An activation switch SW1 is provided to the processor U2 to allow for ON/OFF operation. This switch is in a parallel arrangement with capacitor C18 to prevent spurious switching.

An indicator circuit 404 in FIG. 4 comprises resistor R13 and light emitting diode D2.

In one embodiment, the transmission circuit 28 (e.g. wireless transceiving circuit) comprises voltage dividers R14 and R15 that provide an input to transistor Q4 where the input is modulated by oscillator Q3 and current limiting resistor R16 is provided at the emitter side. Capacitors C21, C22, C23, and C24 help eliminate glitches and prevent spurious signals. A transmission element may be installed between terminals P1 and P2 or, alternatively, an antenna may be connected to terminal P1.

FIG. 5 shows an example of an embodiment of a circuit 500 for the controlled load switch 130. In this embodiment, the circuit 500 for the controlled load switch 130 includes relay driving circuit 56. A relay SW4 connects to the control output (LOAD) of relay driving circuit 56. The ON/OFF of the controlled load switch circuit 500 controlled by the relay SW4. The central processing unit U5 is connected to the control input of relay driving circuit 56. The voltage-stabilizing DC power circuit 54, which is used to output two DC voltages, connects to the CPU central unit circuit 50. The wireless transceiving circuit 28, the LED indicator circuit 52, and the zero-cross sampling circuit 58 all input to the central processing unit U5.

In the embodiment of FIG. 5, the CPU central processing unit 50 of controlled load switch circuit 500 is made of chip U5 and its auxiliary circuit. Single chip U5 is a processor, such as central processing unit. In association with the central processing unit 50, a memory is preferably used to store computer code, which, when executed by the processing unit 50, is used in one embodiment to query the gate action monitor 110, the double sensor 120, and other devices as well as to determine threshold settings and to determine whether to turn activate, deactivate, or otherwise control climate control systems, lighting systems, or the like for the enclosed space.

The zero-cross sampling circuit 58 is made of resistor R32 and filtering capacitor C39. The zero-cross sampling circuit 58 is used to increase the life of the load switch 130.

In power supply system 54, a power supplying input LINE is current limited by resistor R33 before being rectified by diode D7. The output of diode D7 is further smoothed out by capacitor C41 and resistor R34 which together provided an RC time constant that causes the pulsed voltage from diode D7 to assume a smoother more continuous DC level before input to voltage stabilizer U3. Voltage stabilizer U3 in conjunction with inductor L1 provide a 24 volt DC input to three terminal DC voltage level shifter chip U4. DC voltage stabilizer U3 may be comprises of a single integrated circuit chip, multiple integrated circuit chip, discrete components, or combinations thereof. The voltage-stabilizing DC power circuit may be made of single chip U3 as a power supply that receives rectified AC voltage from the LINE and outputs 24 V DC. The voltage-stabilizing DC power circuit also may include an integrated circuit three-terminal voltage level shifter U4 to generate the voltage-stabilizing 5 volt DC power supply from the 24 volt DC power supply generated by voltage stabilizer U3, the 24V DC voltage for coil of relay SW4 and 5V DC voltage for central processing unit U5.

The wireless transceiving circuit 28 connects to the central processing unit U5. The relay driving circuit 51 is made of resistance R31, switch triode Q9 and its auxiliary component. The stabilization of the 24 VDC is accomplished through a pull up network consisting of capacitor C40, diodes D6, D7, D8, electrolytic capacitors C41, C43 On the input side of voltage level shifter U4 an electrolytic capacitor C43 acts to smooth out glitches. On the output side of voltage level shifter U4 a parallel capacitor C44 also smooths out glitches.

In one embodiment, the relay control circuit 56 includes an electromagnet (EM) powered by the 24 VDC supply. The electromagnet EM is activated when the signal LOADP from CPU U5 drives the base of transistor Q9 down. The signal LOADP is current limited by resistor R31. A diode D5 ensures that a bias is applied to the electromagnet EM. The signal zerof from the CPU U5 provides power to the make or break switch SW4. Resistor R41 and capacitor C38 removes or filters glitches. Resistor R29 limits current to the switch SW 4 and provides output LOAD.

An oscillator circuit 59 formed of Q8 provides timing the CPU chip U5. Both terminals of oscillator Q8 are tied to ground through a respective capacitor C33, C34.

Power voltage VDD is provided through a first current limiting resistor R25 that is tied to ground through capacitor C36 to eliminate glitches and then through a second current limiting resistor R26 to provide auxiliary power Vpd to the CPU chip U5. Capacitor 35 removes glitches. CON4 provides a connection to port EXT to allow pairing with the sensors 110, 120. CON3 is connected to CON4. C37 is to stop the button from shaking, while R42 is current limiting transistor .limit D4

Referring to FIGS. 4 and 5, in one embodiment, when the temperature sensor circuit 34 shown in FIG. 4 detects that the indoor temperature is higher than a predetermined upper temperature threshold, such as approximately 28° C., the central processing unit U5 sends a control signal to the relay driving circuit 54 to control relay SW 4 allowing the controlled load switch 130 to remain enabled and for the air conditioning in this example to be activated or to stay activated. When the temperature sensor circuit 34 detects that the indoor temperature is lower than a predetermined lower temperature threshold, such as for example 15° C., the central processing unit U5 sends a second control signal to a second relay driving circuit to control a second relay allowing a controlled load switch for heating to be activated or to stay activated to keep the room at the most comfortable or desired temperature.

FIG. 6 is a block diagram of a second embodiment of the power control system 100. In this embodiment, the system 600 includes a remote host 602. In one embodiment, the remote host 602 is configured to communicate with one or more of the gate action monitor 110, the double signal sensor 120 and the controlled load switch 130 to transfer and exchange data, information and signals. In one embodiment, the remote host 602 is communicatively coupled to the gate action monitor 110 and double signal sensor 120 through a wireless connection or network 604, such a cellular network, the Internet or a WLAN. Alternatively, or additionally, the remote host 602 may communicatively interface and communicate with one or more of the gate action monitor 110, the double signal sensor 120, and the controlled load switch 130. In one embodiment, the remote host 602 may be a personal computer, a handheld device such as a PDA, or a centralized computer facility that offers remote function setting, diagnostics and repair. An example of a remote host 602 is a mobile or handheld communication device, such as a cell phone, pad or tablet with Internet browser capability that allows the user to establish settings remotely for an enclosed space such as a room. Additionally, the power control system 600 of this embodiment may interface with and/or be controlled by the remote host 602, such as a personal computer, personal device assistant, or the like.

Operation

Test Mode:

In one embodiment, when power is applied to the controlled power outlet 230 and the function button 236 on the controlled power outlet 230 is activated, such as by pressing, a “test mode” of the system 100 is initiated. In one embodiment, after pressing the function button 236, the indicator 238 will flash once to indicate the test mode.

In one embodiment, if during the test mode the controlled power outlet 230 receives a signal 218 from the door sensor 210, the controlled receptacle 232 will be activated or enabled, meaning that electrical power is supplied to the controlled receptacle 232. The load 140 will be enabled. The controlled power outlet 230 will enable the controlled receptacle 232 in this test mode for approximately 30 seconds.

If motion is detected during the test mode, the PIR sensor 220 will generate an occupancy signal 226 and send or transmit the occupancy signal 226 once every approximately every 15 seconds. If no motion is detected, the PIR sensor 220 will generate and send a temperature signal 228 approximately every 30 seconds. At the expiration of approximately 5 minutes, the test mode will end and the PIR sensor 220 will enter a normal mode. In one embodiment, when motion is detected or an occupancy signal 226 is generated, the transmission of a temperature signal 228 is inhibited.

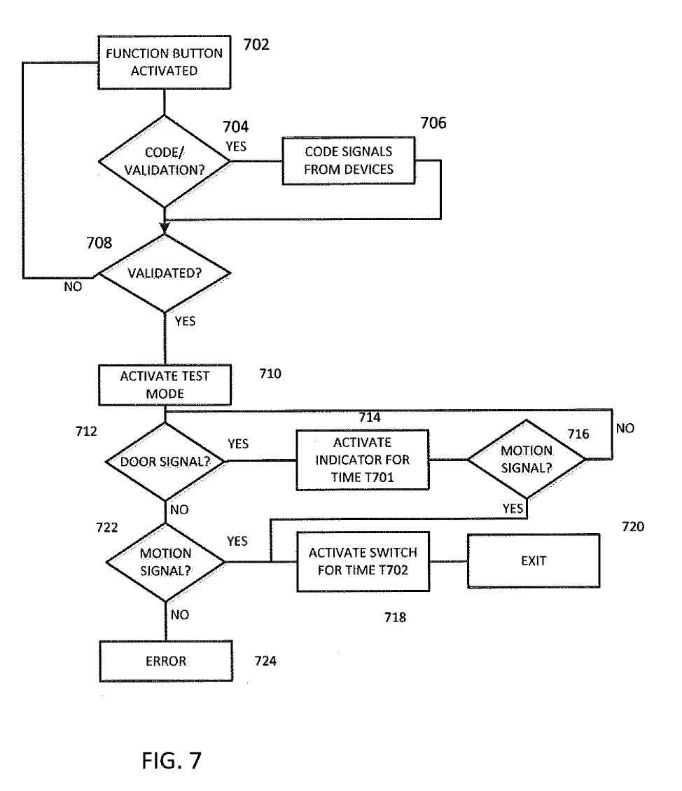

One embodiment of a process for installing and operating a power control system 100 incorporating aspects of the disclosed embodiments is illustrated in FIG. 7. In operation, the function button 236 on the controlled power outlet 230 is actuated 702, such as by pressing. The indicator light 238 may flash for a predetermined time during which or immediately after it is determined 704 whether which a code mode is needed for validation of system components 210, 220 and 230. Each of the components 210, 220 transmits 706 its code signal to the controlled power outlet 230. A successful match of each of the code signals at the controlled power outlet 230 will result in a change in the flash pattern of the indicator light 238. In one embodiment, after a successful matching of each of the code signals from the components 210, 220, validation 708 of the system is complete and the indicator light 238 on the controlled power outlet 230 is turned off. In one embodiment, the order of code signals transmitted 706 can be first from the door sensor 210, and then from the PIR sensor 220. In alternate embodiments, the order of validation 708 of code signals from the components 210, 220 by the controlled power outlet 230 may be interchanged. In one embodiment, the code signals of each of the components 210, 220 may be unique to each other and a particular system 100, as well as the controlled power outlet 230.

After initialization or validation 708, a test mode 710 is enabled when the function button 236 on the control load switch 130 is activated. In the test mode, in one embodiment, opening the door will cause the gate-action monitor 110, referring to FIGS. 1 and 2, to transmit the door open/close signal 218 to the controlled load switch 130. If the door signal 218 is detected 712 by the controlled load indicator 130 the indicator light 238 on the controlled load switch 130 may be activated 714 and display a flash pattern for a period of time T701 that the door open/close signal 218 has been received and is being processed.

In one embodiment, if during the test mode, if the controlled load switch 130 detects 716 a signal 226, 228 from the double signal sensor 120, the controlled load switch 130 will be activated 718 for a predetermined period of time T702 (e.g., 30 seconds). After the predetermined period of time ends, the controlled load switch 130 will turn off 720. If the controlled load switch 130 does not detect 722 an occupancy 226 or temperature signal 228 from the double signal sensor 120 and a signal from the gate action monitor 110 within a predetermined time (e.g., 1 minute), the indicator light 238 on the controlled load switch 130 will commence a flash pattern indicating an error 722. When the test mode period ends successfully, the normal operation of the system 100 commences.

Normal Mode

During a normal operating mode of the system 100, the PIR sensor 220 will detect motion in the associated room as is generally understood by one of skill in the art. In one embodiment, when motion is detected by the PIR sensor 220, the PIR sensor 220 will generate and send an occupancy signal 226 approximately every two minutes. In alternate embodiments, the occupancy signal 226 can be sent at any suitable time interval. When the controlled power outlet 230 detects the occupancy signal 226, it enables or activates the controlled receptacle 232 to provide power to the controlled receptacle 232 and the load 140.

In one embodiment, during periods when the PIR sensor 220 does not detect motion, the PIR sensor 220 will transmit a temperature signal 228. As shown in FIG. 2, the PIR sensor 220 is equipped with a temperature sensor 222 and is configured to detect a temperature, a variation in temperature or a relative temperature of the room. When the PIR sensor 220 does not detect motion in the area or room, the PIR sensor 220 will generate and send a temperature signal approximately every four minutes. It will be noted that the time intervals recited herein are merely exemplary, and in alternate embodiments, any suitable time intervals may be used. In one embodiment, the various time intervals described herein can be varied to suit a particular application or sensor system configuration. For example, it might be desirable in certain applications to send occupancy or temperature signal more or less often than the time intervals recited herein.

As an example of temperature monitoring, in one embodiment, the PIR sensor 220 can be configured to determine when a temperature of the room exceeds approximately 28 degrees Celsius. When such a temperature is detected, the PIR sensor 220 generates temperature signal 228 that informs the controlled power outlet 230 to activate the controlled receptacle 232 to turn load 140 ON. In the example of a load 140 that comprises an air conditioner, power to the air conditioner is provided and the air conditioner can turn ON and begin cooling the room. When the PIR sensor 220 detects that the temperature has dropped a pre-determined amount or to a pre-determined level, such as approximately 24 degrees Celsius, the temperature signal 228 from the PIR sensor 220 can inform the controlled power outlet 230 to deactivate or turn the controlled receptacle OFF, and thus the air conditioner OFF.

While the exemplary embodiments described herein generally pertain to cooling, in one embodiment, the aspects of the system 100 can also be applied to heating a room. For example, if the PIR sensor 220 detects that the temperature of the room has dropped to or below approximately 13 degrees Celsius, the temperature signal 228 generated by the PIR sensor 220 can inform the controlled power outlet 230 to activate the controlled receptacle 232 and turn the load 140, which in this example can comprises a heater or heating system, ON. When the PIR sensor 220 detects that the temperature has risen a pre-determined amount or to a pre-determined temperature, such as for example, approximately 17 degrees Celsius, the temperature signal 228 can inform the controlled power outlet 230 to deactivate the controlled receptacle 232 and turn the load 140 OFF.

In one embodiment, if the controlled power outlet 230 receives a door OPEN/CLOSE signal from the door sensor 210, the controlled power outlet 230 will be prevented or disabled from receiving a signal from the PIR sensor 220 for a period of time, such as for example, approximately 3 minutes.

If a period of time of approximately 5 hours elapses after the receipt of an occupancy signal 226 without any further occupancy signals, in one embodiment, the controlled power outlet 230 will disable or deactivate the controlled receptacle 232, meaning power to the controlled receptacle 232 is turned OFF, and the load 140 is OFF. If the controlled receptacle 232 is enabled and the load 140 is ON, in one embodiment, if no signals are received by the controlled power outlet 230 for a period of approximately 2 hours, the controlled power outlet 230 is deactivated, and the load 140 is turned OFF.

In one embodiment, if the controlled power outlet 230 does not receive a signal 218 from the door sensor 210 for a period of approximately 72 hours, the indicator 238 will flash continuously. Once a door signal 218 is received, the indicator 238 will return to normal operation. The indicator 238 can also be made to flash if no signal is received from the PIR sensor 220 for a period of approximately 24 hours. For example, if the batteries in the door sensor 210 or PIR sensor 220 are low, the sensors 210, 220 will not transmit any signals. In one embodiment, the flashing of indicator 238 when signals are not detected for certain periods of time, can be used to identify low battery states.

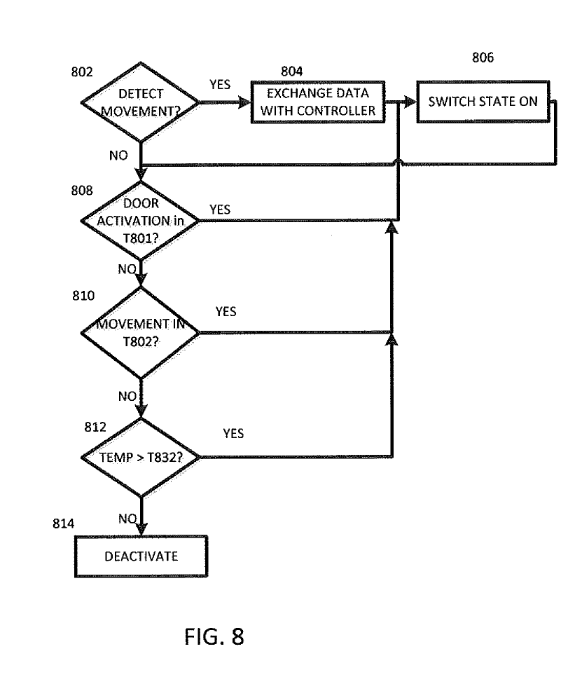

Referring to FIG. 8, one embodiment of a control method incorporating aspects of the present disclosure is illustrated. In this embodiment, in a normal mode the double signal sensor 220 detects 802 movement through a change in an infrared detection signal. The double signal sensor 220 exchanges 804 information with the controlled load switch 130. In one embodiment, the central processing unit U5 of the controlled load switch 130 shown in FIG. 5, controls the relay to connect or maintain connection 806 of the controlled load switch 130 to an electrical power source.

When the gate-action monitor unit 110 detects 808 the first open/close action, such as when a door to a room is opened or closed, and the double signal sensor 220 detects 810 no movement signal indoors within a pre-determined time T801, the gate action monitor 110 exchanges information with the controlled load switch 130 and the central processing unit U5 of controlled load switch 130 commands the relay driving circuit 56 to control the relay SW4 to maintain or initiate 806 the connection of the control load switch 130 to the source of electrical power. When the double signal sensor 220 detects 812 that the temperature inside the room being monitored is higher than a predetermined threshold temperature T832, the central processing unit U5 commands the relay driving circuit 56 to close the relay SW4 or to maintain the state of the relay SW4 such that the controlled load switch 130 is connected 806 to electrical power to operate, for example, the climate controlled system of the room. If it is detected 816 that the temperature is not above T832, in one embodiment, the controlled load switch 130 is deactivated 814 so there is no power to the switch 130 and the load 140. If it is detected 810 that there is motion in time T802, the control load switch 130 remains enabled 806 to provide electrical power to the load 140.

If the gate action monitor unit 110 does not detect 808 a door action and the double signal sensor 220 detects 810 no movement indoors during a predetermined time T802 such as a time between 30 seconds and 10 minutes after activation of the gate action monitor unit 110, the control relay driving circuit 56 will operate to disconnect or keep disconnected 814 the load controlled switch 130 from the electrical power source 150.

When the temperature sensor 222 of the double signal sensor 220 detects 812 that the indoor temperature higher than a predetermined temperature threshold T832 such as, for example, 28° C., the central processing unit U5 commands the relay driving circuit 56 to control relay SW4 to allow enable 806 the control load switch 130 and power the climate control system to cool the room or enclosed space, as through air conditioning or refrigeration. In this example, when the indoor temperature falls below another temperature threshold, such as 25° C., the central processing unit commands the relay driving circuit 56 to control relay SW4 to disconnect or maintain disconnection 814 of the air conditioning or refrigeration system through the controlled load switch 130.

During normal operation, in one embodiment, after the controlled load switch 130 detects a door open/closed signal 218 from the gate action monitor 110, the controlled load switch 130 will time out from interpreting any signal 226, 228 from the double signal sensor 220 for a predetermined period of time (e.g., approximately 3 minutes). In this embodiment, after the controlled load switch 130 detects the signal 218 from the gate action monitor 110, if the controlled load switch 130 does not detect an occupancy signal 226 within a predetermined time period (e.g., approximately five hours), the controlled load switch 130 will turn off or be deactivated. In this embodiment, if the controlled load switch 130 does not detect a temperature signal 228 from the double signal sensor 220 within a predetermined time period (e.g. approximately two hours), the controlled load switch 130 will turn off or be deactivated. If the controlled load switch 130 does not detect a door open/close signal 218 from the gate action monitor 110 during a predetermined time period (e.g. approximately 72 hours), the indicator light 238 of the controlled load switch 130 can be configured to flash continuously, generally indicating an error state during which the controlled load switch 130 will remain deactivated. In this embodiment, the controlled load switch 130 will not revert to a normal operating mode until it detects a signal 226, 228 from the double signal sensor 220. If the controlled load switch 130 does not detect either an occupancy signal 226 or a temperature signal 228 during a predetermined period of time (e.g. approximately 24 hours), the indicator light 238 of the controlled load switch 130 is configured to flash continually to indicate an error state, such as a low battery state of the double signal sensor 220, and the controlled load switch 130 will remain deactivated and not enable electrical power to the load.

In one embodiment, the time periods and predetermined temperatures can be set or varied by the user. For example, one or more of the gate action monitor 110, the double ceiling sensor 220 and controlled load switch 130 can include one or more switches, such as rotary or dip switches, that allow the different time periods and temperature settings and thresholds generally referred to herein to be set or varied. In an embodiment such as that described with respect to FIG. 6 with the remote host 602, the remote host 602 can be used to configure, set and change any one or more of the time periods and temperature settings or thresholds referred to herein. For example, in one embodiment, the user can access a web based interface to the system 100 using the remote host 602. The remote host 602 can provide various configuration pages and states to allow the user to establish the time and temperature settings of the test mode and the normal mode. This can be especially advantageous if the user plans to be away for an extended period, and does not anticipate any one or more of signals 218 or 226 to be generated for extended periods. In this situation, the user can vary the time and temperature settings as needed to accommodate longer or shorter periods of absence, or set higher or lower temperature thresholds for the activation and deactivation of the controlled load switch 130.

In one embodiment, the door open/close signal 218 is used in conjunction with the occupancy signal 226 to determine when to turn the heating or air conditioning system controlled by the controlled load switch 130 ON or OFF. For example, when a door open/close signal 218 is detected by the controlled load switch 130, a timer is started and, if no occupancy signal 218 has been detected before the predetermined time period expires, the controlled load switch 130 is deactivated and the air conditioning or heating system is turned OFF on the presumption that someone had left the room and the room is now empty. If an occupancy signal 226 is detected within a predetermined period of time, as monitored by the time, the controlled load switch is enabled, or remains enabled and the air conditioning or heating system is or remains turned ON, on the assumption that the room is occupied. The temperature data 228 in this embodiment is transmitted by the double signal sensor 220 to the controlled load switch 130.

The aspects of the disclosed embodiments offer advantages such as when infrared sensor 220 detects a signal indicating that a room is occupied, the controlled load circuit 130 is connected to either initiate or maintain climate control. Alternatively, or in addition, after the gate action monitor unit 110 detects a first open and close action as by an entrance door to a room being opened or closed, and the infrared sensor unit 220 detects no movement inside during a predetermined time, such as between 30 seconds and 10 minutes, the central processing unit U5 commands the relay SW4 driving circuit to control the relay SW4 to disconnect or maintain the disconnection of the controlled load switch 130 to achieve the automatic on/off load power function. Further, when the room being monitored is unoccupied, the temperature sensor 222 and controlled load switch 130 may keep the indoor temperature at a pre-determined temperature that promotes cost savings over personal comfort desired were the room occupied. Second, the use of the gate action monitor 110, the double signal sensor 220, and the controlled load switch 130 provide for lower operating costs and feedback information to optimize user enjoyment.

The aspects of the disclosed embodiments are generally directed to a power control system that activates a controlled load switch to provide electrical power to an electrically powered device or system, such as for example, a heating and air condition unit or system or a lighting system in an enclosed space or area. The activation and deactivation, or switching, of the controlled load switch, which is coupled to a suitable source of electrical power is generally based on one or more, or a combination thereof, of signals received from a gate action monitor, such as door switch, and a double signal sensor, such as a PIR sensor. The PIR sensor is configured to detect not only movement, but also a temperature of the enclosed space or area that is being monitored and controlled by the system generally described herein.

Thus, while there have been shown and described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for controlling a power input to a load, comprising:
a gate action monitor configured to transmit a door activation signal corresponding to an opening or closing of an access way to an enclosed space;
a double signal sensor configured to transmit an occupancy signal corresponding to a detected occupancy of the enclosed space and a temperature signal corresponding to a detected temperature of the enclosed space; and
a controlled load switch configured to detect one or more of the door activation signal, occupancy signal and temperature signal, and enable or disable the power input to the load.

2. The system of claim 1, wherein the gate action monitor and double signal sensor each comprise a wireless communication device to enable wireless communication of data and information with the controlled load switch.

3. The system of claim 1, wherein the load is an air conditioning apparatus.

4. The system of claim 1, wherein the gate action monitor is a magnetic door sensor and the double signal sensor is a passive infrared occupancy detection device.

5. The system of claim 1, wherein the controlled load switch comprises:
a connection to a source of AC power;
a switch between the connection to the source of AC power and the power input to the load; and
a processing device configured to enable the switch to connect or disconnect the source of AC power to the power input to the load.

6. The system of claim 5, wherein the processing device is configured to detect occupancy of the enclosed space or a temperature of the enclosed space that is above a pre-determined threshold temperature and enable the switch to connect the source of AC power and the power input to the load.

7. The system of claim 5, wherein the processing device is configured to detect occupancy of the enclosed space or a temperature of the enclosed space that is above a pre-determined threshold temperature and enable the switch to connect the source of AC power and the power input to the load

8. The system of claim 7, wherein the controlled load switch is in an enabled state when the door activation signal is detected and the occupancy signal is detected within a predetermined time period.

9. The system of claim 7, wherein the controlled load switch is in a disabled state when the door activation signal is detected and the occupancy signal is not detected within a predetermined time period.

10. The system of claim 7, wherein the controlled load switch is in an activated state when the temperature signal indicates that a temperature of the enclosed space is above a pre-determined threshold temperature.

11. The system of claim 1, comprising a communication interface communicatively coupled to and between the gate action monitor, double signal sensor and controlled load switch to enable communication of data and commands.

12. A method for controlling a switch to power a load in a monitored enclosed space, comprising:
detecting a door action associated with an entranceway to the enclosed space;
determining an occupancy of the enclosed space; and
activating the switch to power the load when the door action is associated with the detected occupancy of the enclosed space.

13. The method of claim 12, wherein detecting an occupancy of the enclosed space comprises:
detecting motion in the enclosed space within a pre-determined time period from detecting the door action.

14. The method of claim 13, comprising:
monitoring a temperature of the enclosed space if motion is not detected in the enclosed space within the pre-determined time period;
activating the switch to power the load when the temperature is above a pre-determined threshold temperature; and
deactivating the switch to disable the load when the temperature is below the predetermined temperature threshold.

15. The method of claim 13, comprising:
monitoring a temperature of the enclosed space if motion is not detected in the enclosed space within the pre-determined time period;
activating the switch to power the load when the temperature is below a pre-determined threshold temperature; and
deactivating the switch to disable the load when the temperature is above the predetermined temperature threshold.

16. The method of claim 12, comprising deactivating the switch to disable power to the load when occupancy is not detected within the enclosed space within a predetermined time period after detecting the door action.

17. The method of claim 16, comprising:
monitoring a temperature of the enclosed space; and
activating the switch to power the load when the temperature is above a pre-determined threshold temperature.

18. The method of claim 12, comprising:
detecting a door action after the switch is activated;
determining an occupancy of the enclosed space by detecting motion within the enclosed space in a pre-determined time period after the door activation, or, in the absence of detected motion within the pre-determined time period, determining if a temperature of the enclosed space is above or below a pre-determined threshold temperature; and
if the enclosed space is not occupied, deactivating the switch.

19. A system for controlling power to a climate control apparatus of an enclosed space having an access door, comprising:
a gate-action monitor configured to monitor an opening or closing of the access door;
a double signal sensor configured to detect movement within the enclosed space and a temperature within the enclosed space;
a controlled load switch coupled to a supply of electrical power and the climate control apparatus, and configured to enable or disable electrical power to the climate control system based on the door activation and one of the detected movement and the temperature within the enclosed space; and
a communication interface communicatively coupled to and between the gate action monitor, double signal sensor and controlled load switch to enable communication of data and commands.

20. The system of claim 19, wherein the controlled load switch comprises an electrical receptacle coupled to a switching relay unit and a controller.

21. The system of claim 19, wherein the communication interface is an internet-enabled device coupled to the Internet.
